(19) United States
(12) Patent Application Publication
(10) Pub. No.: US 2008/0092583 A1
(43) Pub. Date: Apr. 24, 2008

(54) BEVERAGE FOUNTAIN WITH REMOVABLE FREEZABLE MEMBER

(76) Inventors: Shae Hong, West Hollywood, CA (US); Katherine Papoutsis, Laval (CA); Ken Martin, Montreal (CA)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/552,239

(22) Filed: Oct. 24, 2006

(51) Int. Cl. B67D 5/62; F25D 3/08

(52) U.S. Cl. 62/389; 62/457.2

(57) ABSTRACT

A beverage fountain includes a container and removable freezable member for containing and chilling a beverage. The removable freezable member is placed in or above the interior of the beverage container, in the flow path of a beverage circulating through the fountain to lower the temperature of the beverage. The removable freezable member is maintained in a position within the flow path without disrupting or interfering with circulation of the beverage. The removable freezable member may be a component of the fountain, such as a portion of the central support or one of the trays secured to the central support.

### FIELD OF THE INVENTION

The disclosed invention relates to beverage fountains and more particularly to beverage fountains having a reusable, removable freezable member for chilling a beverage (or other liquid) circulating through the fountain.

### DESCRIPTION OF RELATED ART

It is common at parties and other social gatherings to provide a chilled beverage in a large serving bowl or punch bowl. At more formal affairs, such as weddings, the serving bowl may take the form of a “champagne fountain,” which includes a fountain pump for circulating the beverage and maintaining some minimum liquid level.

It is important for the beverage to remain chilled, which is typically achieved by the provision of ice directly in the bowl or fountain. One problem with ice is that when it melts, it dilutes the beverage. Another approach is to provide a freezable bowl Sometime before the beverage is to be served, the bowl is stored in a refrigerator or freezer to cool or freeze. Thereafter, the chilled bowl is removed from the refrigerator or freezer for use. This approach is preferred to the use of ice because it will not dilute the beverage and can remain cold for a longer period of time than ice, but there are disadvantages as well. For example, it is inconvenient for the user to place the entire bowl in the refrigerator or freezer The bowl usually occupies considerable space, and freezers in general are not so capacious as to have extra room for an item of this large size. Therefore, an improved beverage container is needed that solves the problems of prior art devices.

### SUMMARY OF THE INVENTION

In accordance with one aspect of the present invention, a beverage container and a removable freezable member are provided. The beverage container may include a bottom region and a sidewall extending generally away from the bottom region to define a container interior. A central support extends upwardly from the bottom region, and one of the bottom region and the central support includes an aperture. The removable freezable member is received in the container interior and maintained at a position above the bottom region and/or below the surface of a beverage in the container interior.

In accordance with another aspect of the present invention, a beverage container and a removable freezable member are provided. The beverage container includes a bottom region and a sidewall extending generally away from the bottom region to define a container interior. The removable freezable member is reusable and is positionable in a flow path of a beverage through the fountain.

In accordance with yet another aspect of the present invention, a method of assembling a beverage fountain is provided. A beverage container including a bottom region and a sidewall extending generally away from the bottom region to define a container interior are provided. The removable freezable member is positioned in or above the container interior in a flow path of a beverage through the fountain.

Other aspects, objects, and advantages of the present invention, including the various features used in various combinations, will be understood from the following description according to preferred embodiments of the present invention, taken in conjunction with the drawings in which certain specific features are shown.

### BRIEF DESCRIPTION OF THE DRAWINGS

FIG. 1 is a front perspective view of a fountain having a beverage container;

FIG. 2 is a front perspective view of the beverage container of FIG. 1;

FIG. 3 is a front perspective view of a removable freezable member;

FIG. 3A is a front perspective view of another removable freezable member;

FIG. 3B is a front elevational view of yet another removable freezable member;

FIG. 4 is a cross sectional view of the beverage container of FIG. 2, receiving the removable freezable member of FIG. 3;

FIG. 5 is a split cross sectional view of beverage fountains according to other aspects of the present disclosure;

FIG. 6 is a cross sectional view of a beverage container receiving another removable freezable member;

FIG. 7 is a split cross sectional view of beverage containers according to still other aspects of the present disclosure;

FIG. 8 is a cross sectional perspective view of a suitable pump for use with a fountain according to the present invention;

FIG. 9 is a cross sectional view of a central support for use with fountains according to the present invention;

FIG. 10 is an exploded view of a beverage fountain having a press ring;

FIG. 11 is a cross sectional perspective view of a beverage fountain having a press ring;

FIG. 12 is an exploded view of a beverage fountain having a central support with a support ring;

FIG. 13 is a split cross sectional view of beverage containers having tether members; and

FIG. 14 is an exploded view of a support structure and pump suitable for use with a fountain according to the present invention.

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

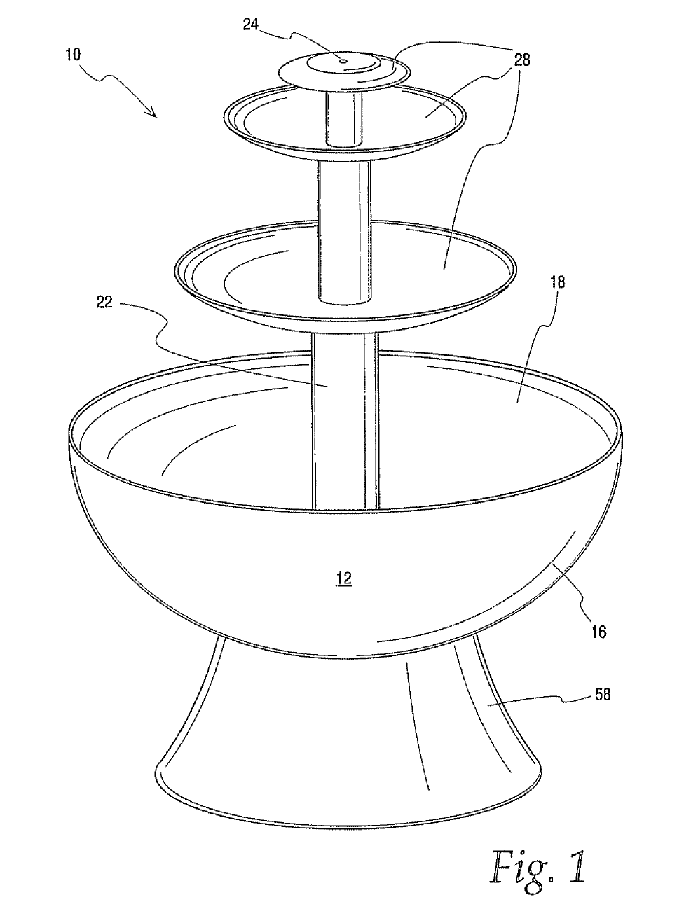

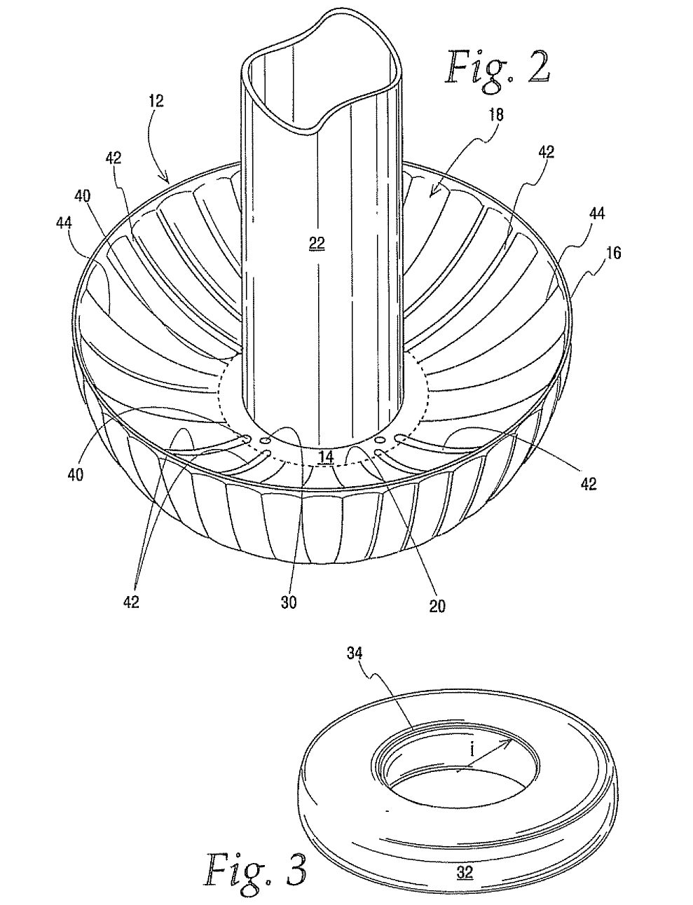

FIG. 1 illustrates a fountain 10 having a beverage container 12 suitable for holding a beverage (not shown). As best illustrated in FIG. 2, the beverage container 12 is defined by a bottom region 14 and a sidewall 16 extending away from the bottom region 14, which cooperate to define an open container interior 18. Preferably, as illustrated in FIGS. 2 and 4-7, the bottom region 14 comprises a lower portion of the sidewall 16, but it can instead be flat or differently shaped from the sidewall 16. In the illustrated embodiment of FIG. 2, there is no distinct boundary between the bottom region 14 and the sidewall 16, but one can be understood as existing generally along broken line 20. Preferably, the beverage container 12 is generally hemispherical or bowl-shaped, although the shape may vary without departing from the scope of the present invention.

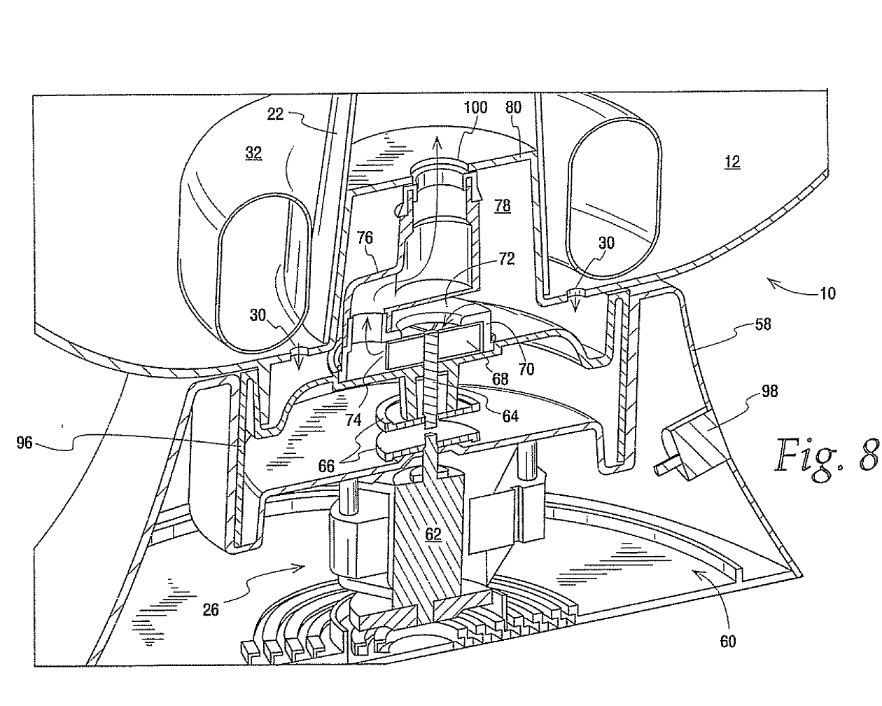

The beverage container 12 may be provided with a generally hollow central support 22 extending upwardly from the bottom region 14. In one embodiment, the beverage container 12 is provided with a generally cylindrical central mount 80 (FIG. 8) adapted to be received within the central support 22. The central support 22 preferably interlocks with the central mount 80 by any of a number of suitable means, such as mating threads or a bayonet joint (not illustrated). Alternatively, the central support 22 may be integrally formed with the beverage container 12.

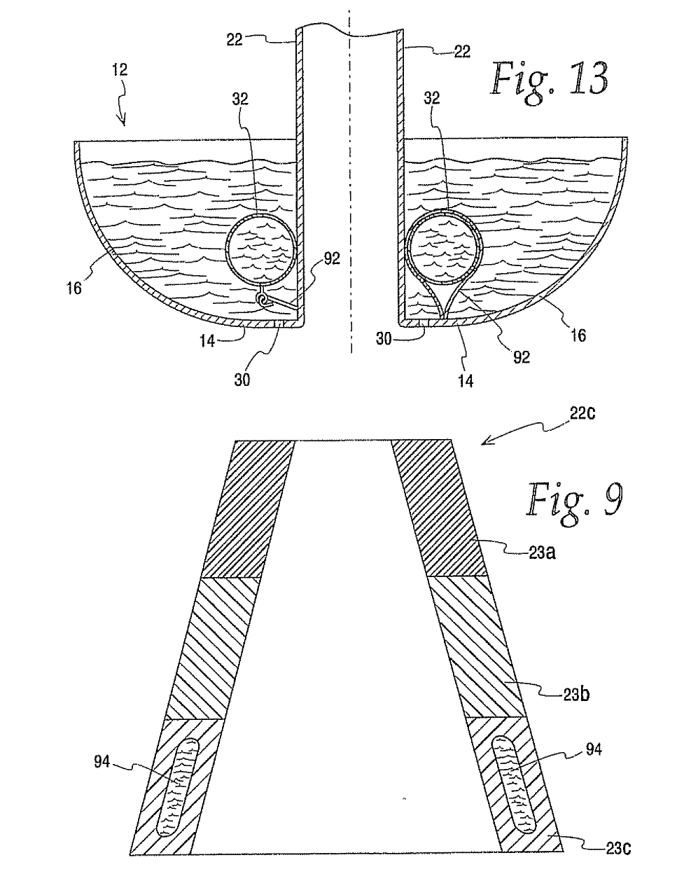

The central support may be provided as a single structure or as a series of mating tubular segments 23a, 23b, and 23c stacked in axial alignment with each other (FIG. 9). It may be preferred to provide the central support 22 in a plurality of support segments, in order to simplify storage and transport. Further, a segmented central support may be disassembled for more easily cleaning the hollow interior.

In a preferred embodiment, the central support 22 is topped by a nozzle 24 (FIG. 1) in fluid communication with a fluid pump 26 (illustrated in FIGS. 4 and 8) and supports a plurality of trays 28 above the beverage container 12. The nozzle 24 and/or trays 28 may be fixedly attached to the central support 22, or may be adapted to be separately mountable on the central support 22. The pump 26 forces the beverage up the height of the central support 22 and out of the nozzle 24. The beverage flows from one tray downward to the next, and finally cascades into the beverage container 12. Fountain pumps are well-known to those of ordinary skill in the art, and any food-grade pump capable of providing an upward flow of consumable fluid may be used in combination with a fountain 10 according to the present invention

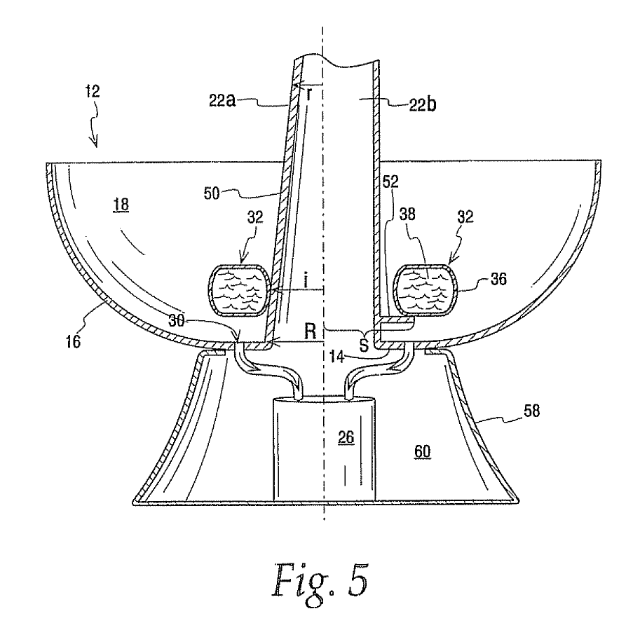

In accordance with one aspect of the present invention, illustrated in FIG. 2, the bottom region 14 defines at least one aperture 30 for draining the beverage container 12 and maintaining a proper liquid level. As illustrated in FIG. 4, liquid drained from the container 12 is returned to the pump 26, which recirculates the liquid through the fountain 10. Alternatively, or in addition to the apertures in the bottom region, apertures 30 may be provided in the central support 22, as illustrated in FIG. 6. The apertures 30 may be located at a higher portion of the central support 22, but it is preferred to position them closer to the bottom region 14 in order to discourage stagnation of the liquid in the beverage container 12. The apertures may serve other purposes without departing from the scope of the present invention. For example, as illustrated in FIG. 5, the apertures 30 may be in a fluid receiving relationship with a pump 26 for filling the container interior 18, rather than using the above-described cascade filling system.

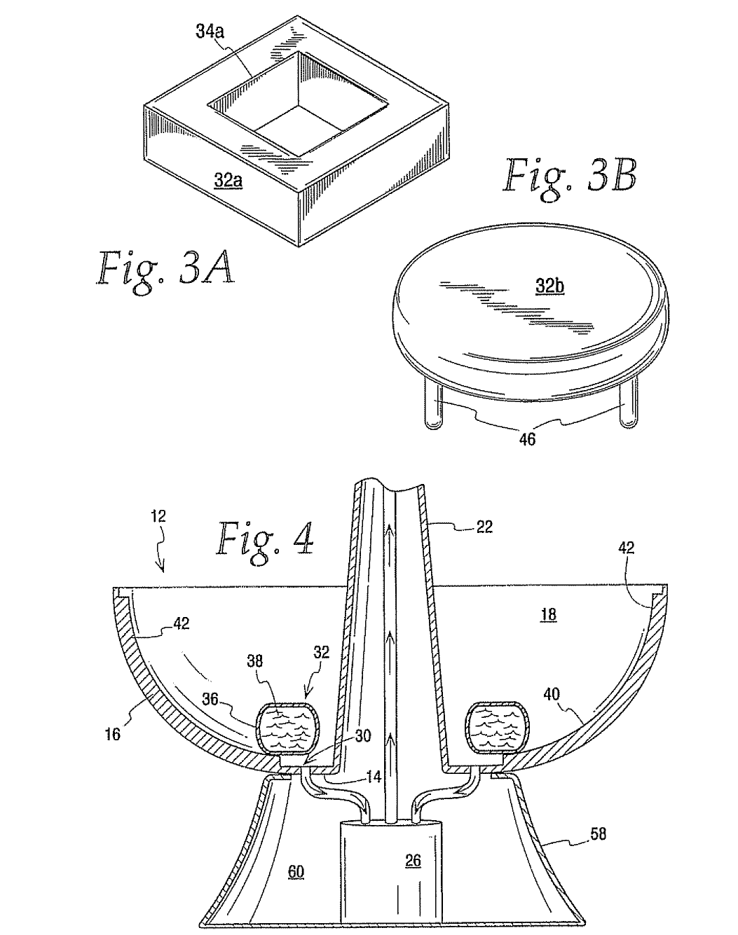

In order to lower the temperature of a beverage within the beverage container 12, a reusable, removable freezable member 32 is provided. FIG. 3 illustrates an embodiment of the removable freezable member 32 having a generally toroidal shape. This is especially preferred for use with a beverage container 12 having a cylindrical or conical central support 26, as shown in FIG. 2, because such a removable freezable member with a generally circular central opening 34 may substantially encircle the central support 26. Such a configuration maintains the removable freezable member 32 in a fixed location with respect to the apertures 30, which may be preferred. A similar effect may be achieved by a non-circular opening or by an opening that is not fully bound by the removable freezable member, such as the opening in an arcuate or C-shaped removable freezable member. Accordingly, the term “central opening” is used broadly herein and is not limited to a circular or fully bounded orifice in the removable freezable member.

The removable freezable member may be installed by sliding it over the central support 22. The trays 28 may be removable to simplify installation and/or removal of the removable freezable member 32. Alternatively, the freezable member may be inserted into the beverage container 12, generally encircling the central mount 80, before the central support 22 is installed.

The removable freezable member 32 is preferably comprised of a non-toxic, food grade plastic shell 36 surrounding a freezable medium 38, as shown in FIG. 4. In a preferred embodiment, the shell 36 is comprised substantially of polypropylene or ABS plastic, while the freezable medium 38 is a liquid or gel, such as water. If the removable freezable member 32 is allowed to float on the surface of the beverage in the beverage container 12, the unsubmerged portion will not contribute to cooling the beverage. Therefore, the removable freezable member 32 may be configured to sink below the surface of the beverage to the bottom region 14 or be constrained to float at some vertical elevation between the surface of the beverage and the bottom region 14. To discourage the removable freezable member 32 from floating, it may be provided with a weighted member, not illustrated, or a relatively dense, non-buoyant freezable medium 38 that reduces the buoyancy of the freezable member 32.

The removable freezable member may have virtually any shape without departing from the present invention. For example, a removable freezable member 32a may be generally square, as illustrated in FIG. 3A, and may have a square central opening 34a adapted for use with a pyramidal or box-shaped central support having a square cross-sectional perimeter or footprint (not illustrated). Furthermore, although it is preferable to provide the removable freezable member with a central opening having a shape generally conforming to the outer profile or cross-sectional perimeter of the central support, the central opening and central support may be differently shaped.

In addition to providing the removable freezable member in various shapes, it may also be provided in two or more parts that cooperate to generally surround or encircle a portion of the central support 22. For example, the removable freezable member 32 of FIG. 3 may be provided as two arcuate halves or segments positionable about the central support 22. If provided as a plurality of parts, then the parts are preferably securable to each other or to the central support 22, by for example a latching mechanism or other retention means, to prevent the parts from migrating away from the apertures 30.

As described above, if provided, the apertures 30 drain liquid from or provide liquid to the container 12, 50 it is important that fluid flow therethrough is not impeded. On the other hand, it is preferable to provide the removable freezable member 32 in the fluid flow path adjacent to the apertures 30 in order to chill the beverage as it moves through the apertures 30. Thus, positioning means may be provided to support the removable freezable member 32 adjacent to the apertures 30 without impeding fluid flow.

In accordance with one aspect of the present invention, at least one projection 40, but preferably a plurality of projections 40, is provided for supporting the removable freezable member 32. In the embodiment of FIGS. 2 and 4, an upward projection 40 extends from the bottom region 14. In a preferred embodiment, the apertures 30 are generally arranged about the central support 22, while the upward projections 40 are comprised of ribs 42 extending along the container interior 18 from the sidewall 16 to the bottom region 14. However, it will be appreciated from the following description that the apertures 30 and projections 40 may be provided in different configurations without departing from the scope of the present disclosure As described above, the apertures 30 may be associated with the central support 22, as shown in FIG. 6. Furthermore, the upward projections 40 need not be provided as ribs 42, but may be smaller, isolated bumps, not illustrated, extending upwardly from the bottom region 14. This may be preferred in order to minimize the volume of the container interior 18 occupied by the projections 40.

If the projections 40 are provided as ribs 42, as illustrated in FIG. 2, the sidewall 16 may include shorter ribs 44 that do not extend to the bottom region 14 or other ornamentation in order to provide the beverage container 12 with enhanced aesthetic appeal. If the projections 40 are provided as ribs 42, then it may be preferred to also provide shorter ribs 44, because they tend to disguise the function of the full ribs 42.

Another alternative in practicing the present invention is to use a removable freezable member 32b (FIG. 3B) which itself is provided with projections 46 adapted to prevent blockage of the apertures 30. The illustrated removable freezable member 32b resembles a stool, with projections 46 engageable with or to rest upon the bottom region 14 and thereby separating the removable freezable member 32b from the apertures 30. Although the projections 46 preferably extend from the bottom of the removable freezable member 32b, they may extend from the sides, top, and/or central opening and extend downwardly to contact the bottom region 14. Also, the projections may extend radially, rather than downwardly, so as to engage the sidewall 16. FIG. 6 illustrates a removable freezable member 32c having finger-like projections 48 that extend to contact the sidewall 16, thereby providing a clear flowpath for the openings 30, which are illustratively located at a lower portion of the central support 22. If the removable freezable member is provided with projections, then it may be used instead of or in combination with a beverage container 12 having upward projections 40.

In another alternative embodiment, the removable freezable member 32 may be supported by the central support 22, in which case the bottom region 14 may be provided without projections. Two possible central supports 22a and 22b are illustrated in split view in FIG. 5. Preferably, such central supports 22a and 22b are used in combination with a generally circular central opening 34 of the removable freezable member 32.

The left side of FIG. 5 illustrates a generally conical central support 22a, which has an outer surface 50 that tapers from a relatively small upper radius r to a radius R larger than an inner radius i of the removable freezable member 32, Thus, in use, the removable freezable member 32 is slid onto the central support 22a until it forms an interference fit therewith some distance above the aperture 30. It will be appreciated that the outer surface 50 need not be conical, as illustrated in FIG. 5, but may be curved or otherwise adapted to provide a relatively large radius R generally adjacent to the container bottom region 14, and a smaller upper radius r suitable for receiving a central opening 34 of the removable freezable member 32.

The right side of FIG. 5 illustrates a central support 22b having a radially extending support ring 52. The radius S of the support ring 52 is greater than the inner radius i of the removable freezable member 32, such that the support ring 52 serves as a platform to support the removable freezable member 32 some distance above the apertures 30.

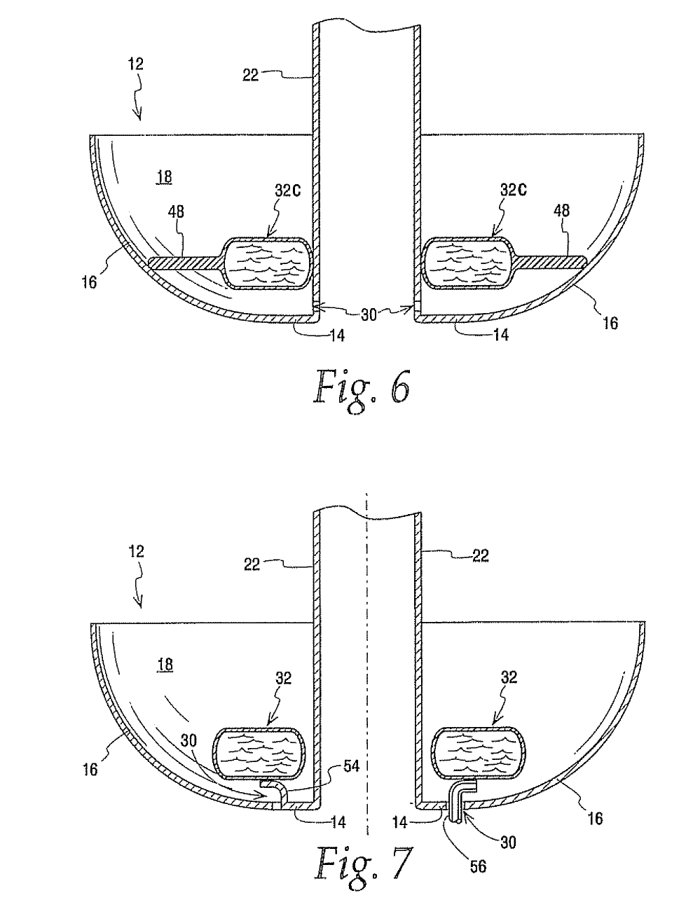

FIG. 7 is a split view of two projections comprising conduits associated with the apertures 30 for simultaneously supporting the removable freezable member 32 and directing fluid into the associated aperture 30. The left side of FIG. 7 shows an aperture 30 incorporating a projection 54 resembling an elbow joint. The right side of FIG. 7 illustrates how a similar effect may be achieved by providing the aperture 30 with tubing 56 extending into the container interior 18. Such an approach may be preferred for use with containers 12 incorporating a recirculation pump 26 to direct beverage to the pump 26. The tubing 56 is preferably flexible, but sufficiently rigid to resist collapsing under the weight of the removable freezable member 32.

As described herein, the removable freezable member 32 may be adapted to be maintained at a vertical elevation between the surface of the beverage and the bottom region 14 of the beverage container 12 (referred to herein as an “intermediate height”). According to one embodiment, the buoyancy of the removable freezable member 32 may be calibrated to float at an intermediate height, for example, by selection of a suitable freezable medium 38 and/or weighted member. However, varying beverages tend to have varying densities, so a removable freezable member calibrated to float at an intermediate height in one beverage will not necessarily also float at an intermediate height in another beverage. Therefore, it may be preferred to provide a relatively buoyant removable freezable member and positioning means for maintaining the freezable member at an intermediate height.

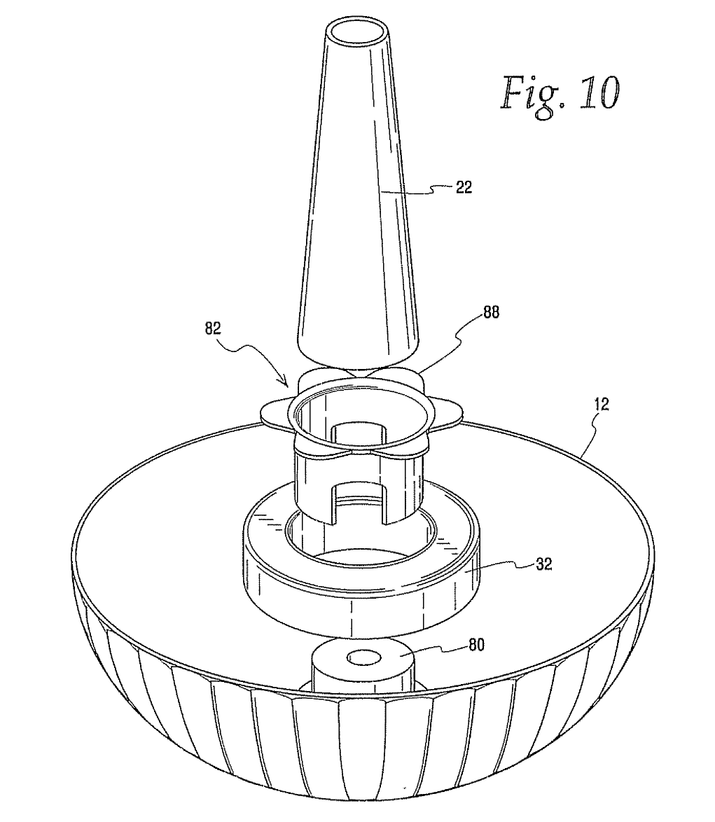

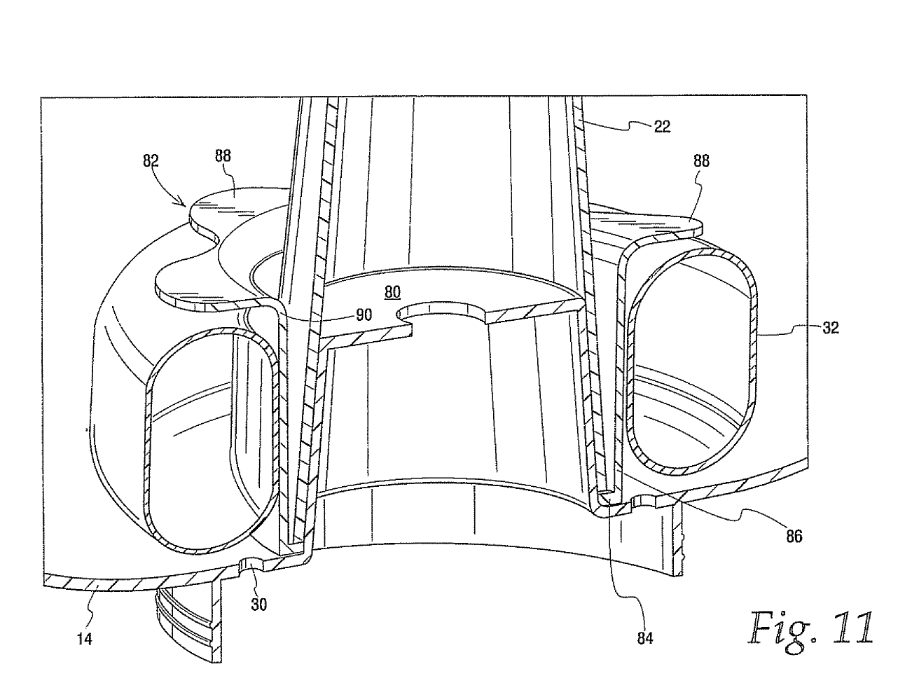

Any of a number of means are suitable for maintaining a buoyant removable freezable member at an intermediate height. For example, a press ring 82 may be provided to fit between the central support 22 and the removable freezable member 32 (FIGS. 10 and 11). The illustrated press ring 82 has inwardly extending feet 84 at a lower end 86 and outwardly extending fingers 88 at an upper end 90. The feet 84 are pinned between the central support 22 and the bottom region 14 of the container 12 to maintain the press ring 82 in position, but other means may be used to hold the press ring 82 in place, such as a press fit with the central support 22. The undersides of the fingers 88 contact the buoyant removable freezable member 32 and prevent it from floating to the surface of the beverage. Preferably, the fingers 88 are positioned at a height greater than the height of the removable freezable member 32, such that the removable freezable member 32 floats above the bottom of the container 12 to avoid obstructing the apertures 30 (FIG. 11). The fingers 88 may be virtually any shape and are not limited to the illustrated “flower” shape, provided that they extend sufficiently outward in a radial direction to abut the removable freezable member 32 and limit its upward movement.

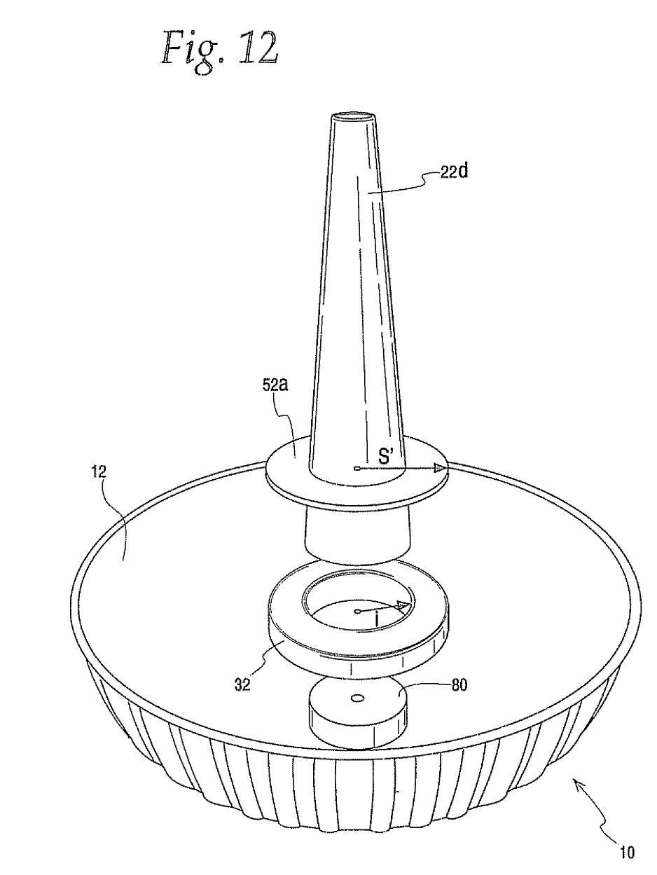

FIG. 12 illustrates a variation of the fountain of FIGS. 10 and 11, wherein the fountain 10 is provided without a press ring 82, but the central support 22d includes a radially extending support ring 52a comparable in structure to the support ring 52 of FIG. 5 and identical in function to the fingers 88 of the press ring 82 of FIGS. 10 and 11. However, the support ring 52a is not limited to the illustrated annular configuration and may be provided in a variety of other configurations, such as the “flower” shape of the press ring fingers 88. The radius S′ of the support ring 52a is greater than the inner radius i of the removable freezable member 32, such that the support ring 52a constrains the buoyant removable freezable member 32 from rising beyond a fixed elevation, which is preferably below a nominal beverage level. Again preferably, the level of the removable freezable member 32 is near the bottom of the beverage container 12. This embodiment may be preferred to the embodiment of FIGS. 10 and 11 because it eliminates the press ring component, thereby simplifying assembly of the fountain.

According to yet another embodiment, a buoyant removable freezable member 32 may be secured to the container 12 or central support 22 by strings, wires, cables, poles, or similar tether member 92 (FIG. 13). The tether member 92 may be flexible or rigid and preferably has a length selected to maintain the removable freezable member 32 beneath the surface of a beverage in the container 12. The tether member 92 may be looped or hooked about the removable freezable member 32 (right side of FIG. 13) or a portion thereof (left side of FIG. 13) or affixed thereto in any of a number of other ways. Preferably, the tether member 92 is detachably connectable to the removable freezable member 32, such that the removable freezable member 32 may be separated from the fountain 10 to be chilled prior to use.

If the removable freezable member is generally annular and the central support is cylindrical or conical, each may be provided with mating threads (not illustrated), on a portion of the outer surface of the central support and at least a portion of the central opening of the removable freezable member, such that the removable freezable member may be screwed onto the central support. Preferably, the external threads on the central support are positioned such that the removable freezable member is positioned within the container interior, above the bottom region and below the surface of a beverage in the container.

These positioning means are not exclusive, but may be used in combination with each other to maintain the removable freezable member at an intermediate height. Furthermore, this list of possible means is intended to be illustrative, rather than exhaustive, and other means may be used without departing from the scope of the present invention.

Alternatively, instead of positioning the removable freezable member within the container interior, it may be positioned within the beverage flow path above the container. For example, the removable freezable member may be adapted to rest on one of the trays or adjacent to the nozzle, preferably positioned so as to come into contact with the flowing beverage as it moves downwardly to the container interior (not illustrated).

According to yet another embodiment, instead of providing a separate removable freezable member, a component of the fountain itself may comprise a removable freezable member In particular, the central support 22 (or a portion thereof) or one of the trays 28 may include an inner freezable layer. For example, FIG. 9 illustrates a conical, segmented central support 22c comprising a plurality of stackable support segments 23a-c, the lowermost segment 23c including an inner freezable layer 94. A unitary central support with an inner freezable layer may be provided instead of a segmented central support, but the segmented construction may be preferred because only a single segment needs to be chilled, thereby occupying less space in a refrigerator or freezer than a complete support. It will be appreciated that a support segment or tray or even an entire central support provided as a removable freezable member is preferable to a freezable container or bowl component, because they occupy much less space in a refrigerator or freezer prior to use.

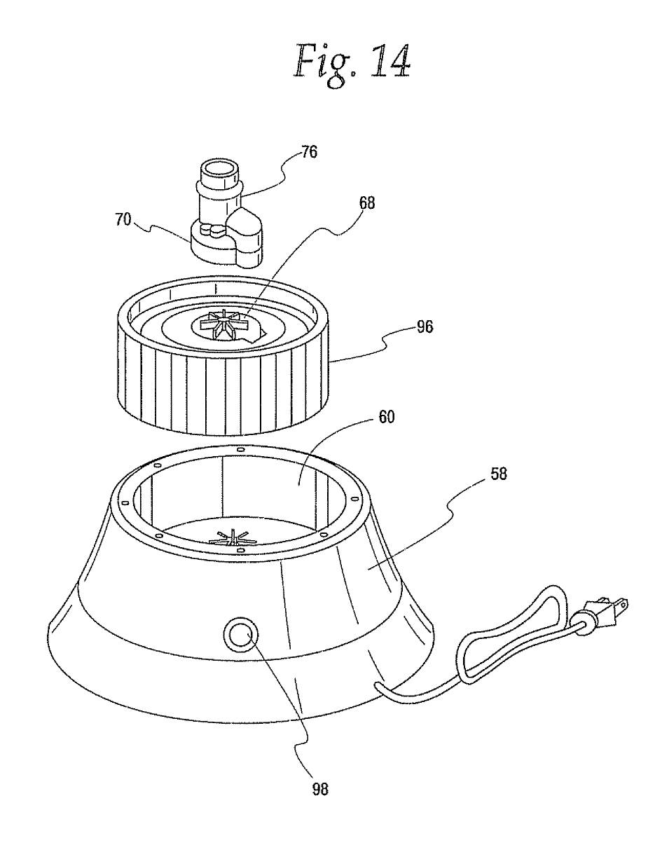

The container 12 may be provided with additional features without departing from the scope of the present disclosure. For example, in a preferred embodiment, best illustrated in FIGS. 8 and 14, the fountain 10 is provided with a support structure 58 that defines a chamber 60 which illustratively, though not necessarily, is located generally beneath at least a portion of the container bottom region 14. The chamber 60 may be in fluid communication with the container interior 18 through the apertures 30, but is preferably separated from the beverage by an intermediate structure, such as a generally disk-shaped collar 96 (FIGS. 8 and 14). The chamber 60 may house selected components of the fountain pump 26, illustratively a pump motor 62 and a power switch 98 for operating the pump motor 62. In the embodiment of FIGS. 8 and 14, other components of the pump 26 are maintained within the collar 96 and/or extending upwardly from the collar 96, as will be described in greater detail herein. Alternatively, the pump 26 may be disposed elsewhere, such as within the central support 22, without departing from the scope of the present invention.

FIG. 8 illustrates a preferred pump 26 for use with a beverage container according to the present invention. The pump 26 is housed primarily within the chamber 60, but extends upwardly into the collar 96 and the central mount 80. The pump 26 includes a motor 62 rotationally associated with a shaft 64 by a clutch 66. The motor 62 drives the shaft 64 to rotate a fan 68. The fan 68 is surrounded by a fan casing 70 defining a drain or fluid inlet 72 generally above the fan 68 and a fluid outlet 74 communicating with a conduit 76. In use, beverage in the beverage container 12 drains through the apertures 30 and into a cavity 78 surrounding the fan casing 70. The unnumbered arrows of FIG. 8 illustrate the general flow of beverage. When the beverage in the cavity 78 reaches a sufficient level, it spills into the fluid inlet 72 and enters the fan casing 70, The shaft 64 may include a fluid seal to prevent beverage from leaking out of the fan casing 70. The beverage in the fan casing 70 is forced by the rotating fan 68 out of the fluid outlet 74 and into the conduit 76. Thereafter, the beverage is forced upwardly through an opening 100 in the central mount 80 and into the interior of the central support 22 to be recirculated through the fountain 10. It will be appreciated by those of ordinary skill in the art that the illustrated pump is merely exemplary, and other pumping configuration may be provided to achieve similar results.

It will be understood that the embodiments of the present invention which have been described are illustrative of some of the applications of the principles of the present invention. Numerous modifications may be made by those skilled in the art without departing from the true spirit and scope of the invention, including those combinations of features that are individually disclosed or claimed herein.

1. A beverage fountain comprising:
a beverage container including a bottom region and a sidewall extending therefrom to define a container interior adapted to receive an amount of a beverage;
a central support extending upwardly from the bottom region;
an aperture in one of the bottom region and the central support;
a removable freezable member to be received in the container interior; and
positioning means for maintaining the removable freezable member at a position above the bottom region and/or below the surface of a beverage in the container interior.

2. The beverage fountain of claim 1, wherein the positioning means is associated with the container interior.

3. The beverage fountain of claim 2, wherein the positioning means comprises a projection extending upwardly from the bottom region.

4. The beverage fountain of claim 2, wherein the positioning means comprises a rib extending along the container interior from the sidewall to the bottom region.

5. The beverage fountain of claim 1, wherein the positioning means comprises a press ring mountable about the central support and including a plurality of outwardly extending fingers.

6. The beverage fountain of claim 1, wherein the positioning means is associated with the central support.

7. The beverage fountain of claim 6, wherein at least a portion of the central support is tapered from a relatively small upper radius to a relatively large lower radius adjacent to the bottom region, and wherein the central support is adapted to support the removable freezable member at a position between the upper radius and the lower radius.

8. The beverage fountain of claim 6, wherein said positioning means comprises a radially extending projection of the central support.

9. The beverage fountain of claim 1, wherein the positioning means is associated with the removable freezable member.

10. The beverage fountain of claim 1, wherein said positioning means comprises a tether member.

11. The beverage fountain of claim 1, wherein the removable freezable member is adapted to be substantially non-buoyant in a beverage in the container interior, and wherein said positioning means substantially prevents said freezable member from impeding fluid flow through said aperture.

12. The beverage fountain of claim 1, wherein the removable freezable member is adapted to be substantially buoyant in a beverage in the container interior, and wherein said positioning means prevents the removable freezable member from floating to the surface of the beverage.

13. A beverage fountain comprising:
a beverage container including a bottom region and a sidewall extending therefrom to define a container interior; and
a reusable, removable freezable member to be received in or above the container interior and positionable in a flow path of a beverage through the fountain.

14. The beverage fountain of claim 13, further comprising a central support extending upwardly from the bottom region, wherein the removable freezable member includes a central opening positionable adjacent to the central support.

15. The beverage fountain of claim 14, wherein at least a portion of the central support is receivable by the central opening of the removable freezable member.

16. The beverage fountain of claim 15, wherein the removable freezable member is generally toroidal and adapted to encircle the central support within the container interior.

17. The beverage fountain of claim 13, further comprising a central support extending upwardly from the bottom region and a plurality of trays axially spaced along the central support, wherein at least one of said trays comprises the removable freezable member.

18. The beverage fountain of claim 13, further comprising a central support extending upwardly from the bottom region and comprised of a plurality of support segments adjoinable in axial alignment with each other, wherein at least one of said support segments comprises the removable freezable member.

19. The beverage fountain of claim 13, further comprising a central support extending upwardly from the bottom region, wherein said central support comprises the removable freezable member.

20. A method of assembling a beverage fountain, comprising:
providing a beverage container including a bottom region and a sidewall extending therefrom to define a container interior; and
positioning a reusable, removable freezable member in or above the container interior in a flow path of a beverage through the fountain.
